(19) United States
(12) Patent Application Publication
(10) Pub. No.: US 2025/0279613 A1
(43) Pub. Date: Sep. 4, 2025

(54) Connector

(71) Applicant: TE Connectivity Japan G. K., Kawasaki-shi (JP)

(72) Inventor: Kiyotaka Mizuno, Shizuoka (JP)

(73) Assignee: TE Connectivity Japan G. K., Kawasaki-shi (JP)

(21) Appl. No.: 19/064,868

(22) Filed: Feb. 27, 2025

(30) Foreign Application Priority Data
Feb. 29, 2024 (JP) 2024-030155

(51) Int. Cl. H01R 13/629

(52) U.S. Cl. CPC H01R 13/62977

(57) ABSTRACT

A connector adapted to mate with a mating connector includes an outer housing, a slider, and an operation lever. The outer housing is adapted to receive the mating connector, and includes a catching portion. The slider is provided in the outer housing and is slidingly movable in a predetermined direction. The slider includes a catching portion adapted to deflect at a predetermined position and to be caught by the catching portion of the outer housing. The operation lever is combined with the slider and is adapted to be turned between a pre-turning first position and a post-turning second position. The slider is slidingly movable with the turning of the operation lever. The catching portion of the slider and the operation lever in the first position can be caught on the caught portion of the outer housing.

### CROSS-REFERENCE TO RELATED APPLICATION

This application claims the benefit of Japanese Patent Application No. 2024-030155 filed on Feb. 29, 2024, the whole disclosure of which is incorporated herein by reference.

### FIELD OF THE DISCLOSURE

The present disclosure relates to a connector. Specifically, the present disclosure relates to a connector having a lever mechanism.

### BACKGROUND OF THE INVENTION

In the prior art, a connector including a lever mechanism for reducing a force required to mate with a mating connector. Such a connector includes a housing, a sliding member (equivalent to a slider), and an operation lever for slidingly moving the slider. Turning operation of this operation lever causes a cam pin of the mating connector to move along a cam groove formed in the slider, thereby mating the connector and the mating connector.

A connector having a conventional lever structure has a problem to be overcome. Specifically, during a mating operation of the connector having such a lever structure as mentioned above, with the operation lever in an initial position (that is, a pre-turning position of the operation lever), the connector and the mating connector are combined. In the connector of the prior art, the operation lever is retained by means of a protrusion provided on a cover. That is, the operation lever is sufficiently retained by means of such a protrusion, and therefore, if load is applied to the operation lever, the operation lever may be unintentionally detached from the protrusion and displaced from the initial position, resulting in a reduction in working efficiency in the mating operation.

The present disclosure has been made in view of such a problem. Therefore, an object of the present disclosure is to provide a connector having a more suitable operation lever retaining mechanism.

### SUMMARY OF THE INVENTION

According to an embodiment of the present disclosure, a connector adapted to mate with a mating connector includes an outer housing, a slider, and an operation lever. The outer housing is adapted to receive the mating connector, and includes a catching portion. The slider is provided in the outer housing and is slidingly movable in a predetermined direction. The slider includes a catching portion adapted to deflect at a predetermined position and to be caught by the catching portion of the outer housing. The operation lever is combined with the slider and is adapted to be turned between a pre-turning first position and a post-turning second position. The slider is slidingly movable with the turning of the operation lever. The catching portion of the slider and the operation lever in the first position can be caught on the caught portion of the outer housing.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 is an isometric view schematically showing a connector of the present disclosure with an operation lever in a first position;

FIG. 2 is a front view schematically showing a connector of the present disclosure in a temporarily mated state with a mating connector with the operation lever in the first position and;

FIG. 3 is a front view schematically showing a connector of the present disclosure (an outer housing which is a component thereof is not shown) in the temporarily mated state with the mating connector with the operation lever in the first position;

FIG. 4A is an isometric view schematically showing the outer housing of the connector of the present disclosure;

FIG. 4B is an isometric view schematically showing the outer housing of the connector of the present disclosure as seen from a different angle from FIG. 4A;

FIG. 4C is a front view schematically showing the outer housing of the connector of the present disclosure;

FIG. 4D is an end view schematically showing the outer housing of the connector of the present disclosure;

FIG. 4E is a top view schematically showing the outer housing of the connector of the present disclosure;

FIG. 5 is an isometric view schematically showing an inner housing of the connector of the present disclosure;

FIG. 6A is an isometric view schematically showing a slider of the connector of the present disclosure;

FIG. 6B is a front view schematically showing an inner main face of the slider of the connector of the present disclosure;

FIG. 6C is a bottom view schematically showing the slider of the connector of the present disclosure;

FIG. 6D is a cross-sectional view schematically showing the slider of the connector of the present disclosure as seen from one end face side;

FIG. 7 is an isometric view schematically showing a cover with the operation lever of the connector of the present disclosure pivotally supported thereon;

FIG. 8 is an isometric view schematically showing the mating connector mateable with the connector of the present disclosure;

FIG. 9 is a front view schematically showing the connector of the present disclosure (the outer housing which is a component thereof is not shown) at the time of unexpected turning of the operation lever before temporary mating with the mating connector;

FIG. 10 is a partially enlarged front view schematically showing a behavior of a catching portion of the slider which is a component of the connector of the present disclosure at the time of unexpected turning of the operation lever before temporary mating with the mating connector;

FIG. 11 is a front view schematically showing an inner main face of an alternative example of the slider of the connector of the present disclosure;

FIG. 12 is a cross-sectional view schematically showing the alternative example of the slider of the connector of the present disclosure as seen from one end face side;

FIG. 13 is a cross-sectional view schematically showing the alternative example of the slider of the connector of the present disclosure as seen from a bottom side; and

FIG. 14 is a front view schematically showing an inner main face of a further alternative example of the slider of the connector of the present disclosure.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A connector according to an embodiment of the present disclosure will be specifically described below with reference to the drawings. Each element in the drawings is schematically and illustratively shown merely for describing the present disclosure, and may have a different exterior, dimensional ratio, and/or the like from an actual one.

First, in order to grasp a general structure of the connector of the present disclosure, a basic configuration of the connector of the present disclosure will be described below with reference to the drawings.

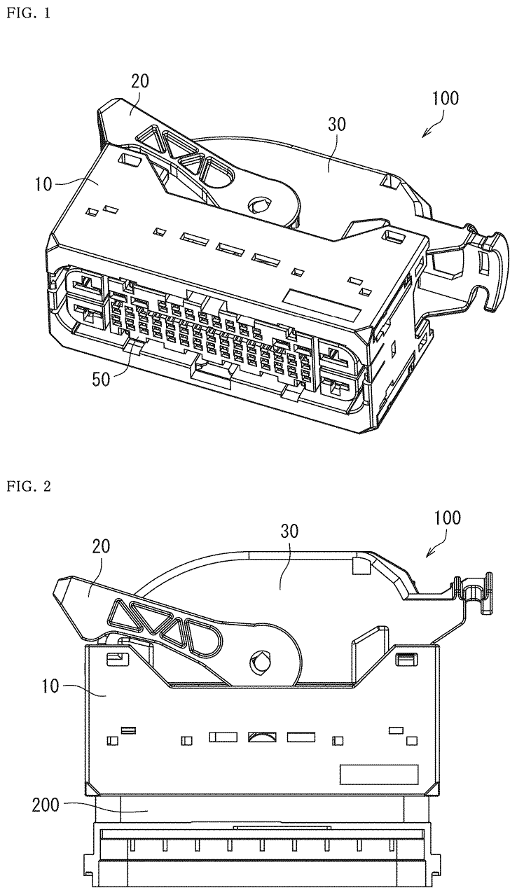

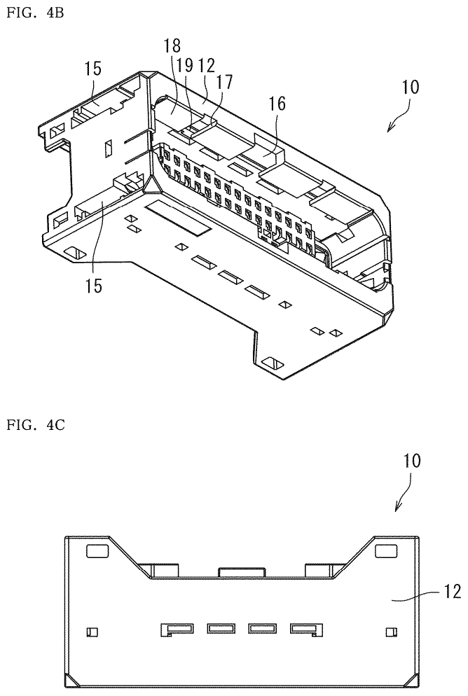

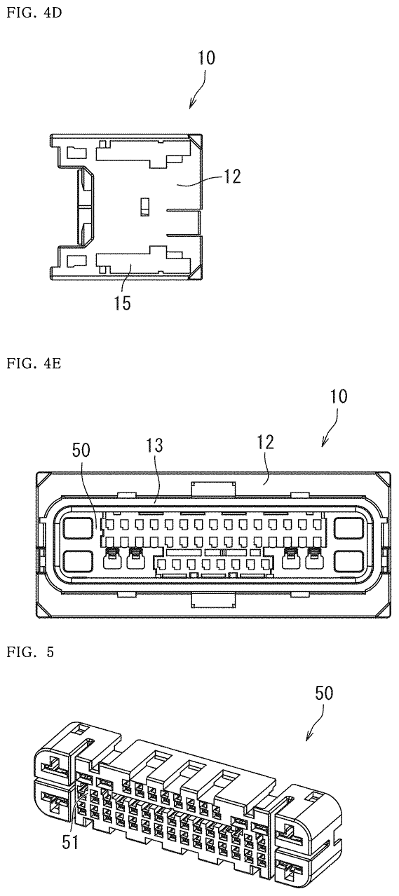

FIG. 1 is an isometric view schematically showing the connector of the present disclosure with an operation lever in a first position. FIG. 4A is an isometric view schematically showing an outer housing of the connector of the present disclosure. FIG. 4B is an isometric view schematically showing the outer housing of the connector of the present disclosure as seen from a different angle from FIG. 4A. FIG. 4C is a front view schematically showing the outer housing of the connector of the present disclosure. FIG. 4D is an end view schematically showing the outer housing of the connector of the present disclosure. FIG. 4E is a top view schematically showing the outer housing of the connector of the present disclosure. FIG. 5 is an isometric view schematically showing an inner housing of the connector of the present disclosure.

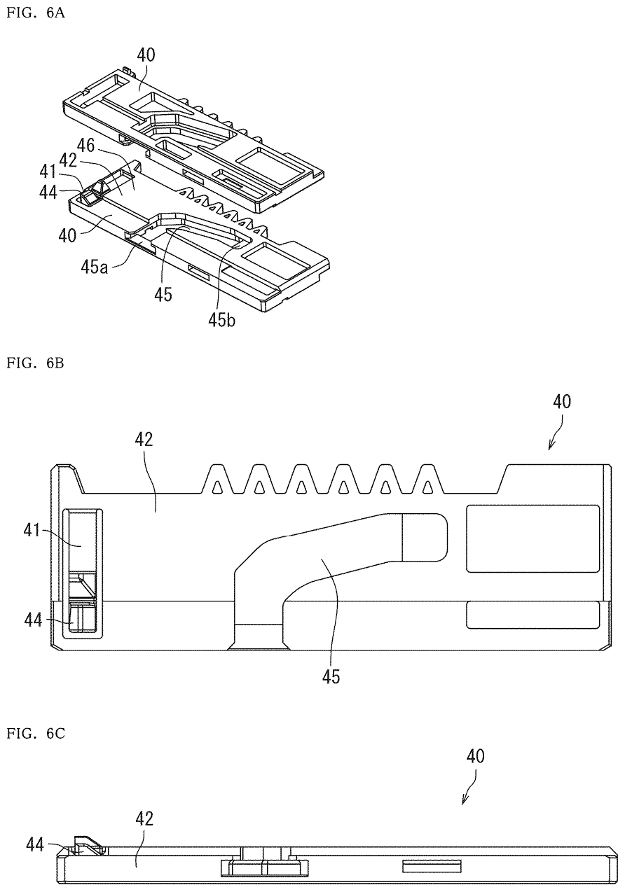

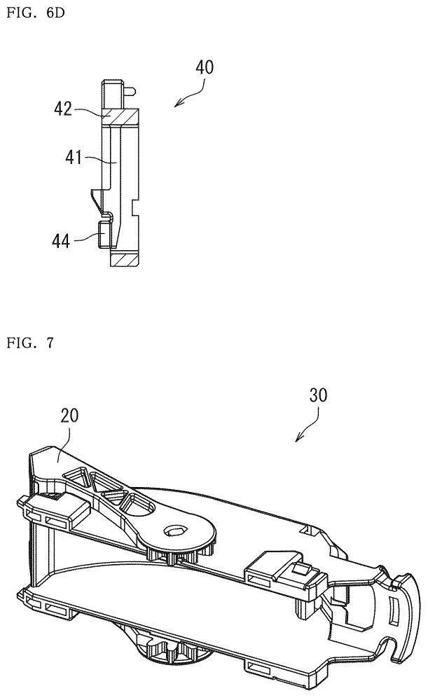

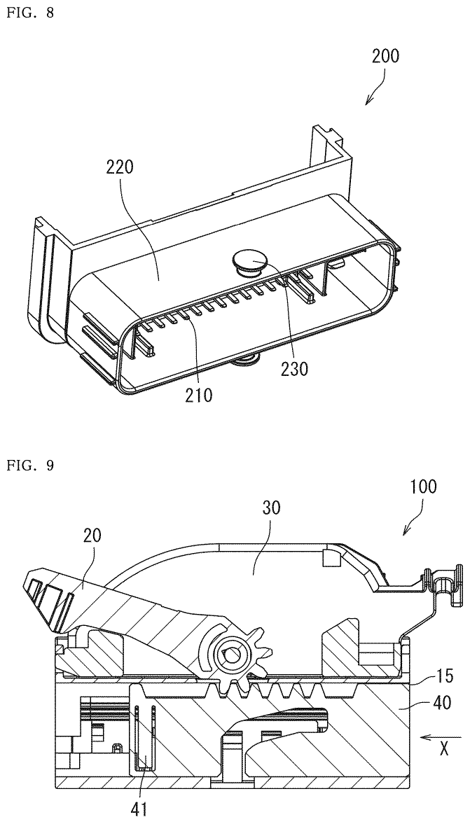

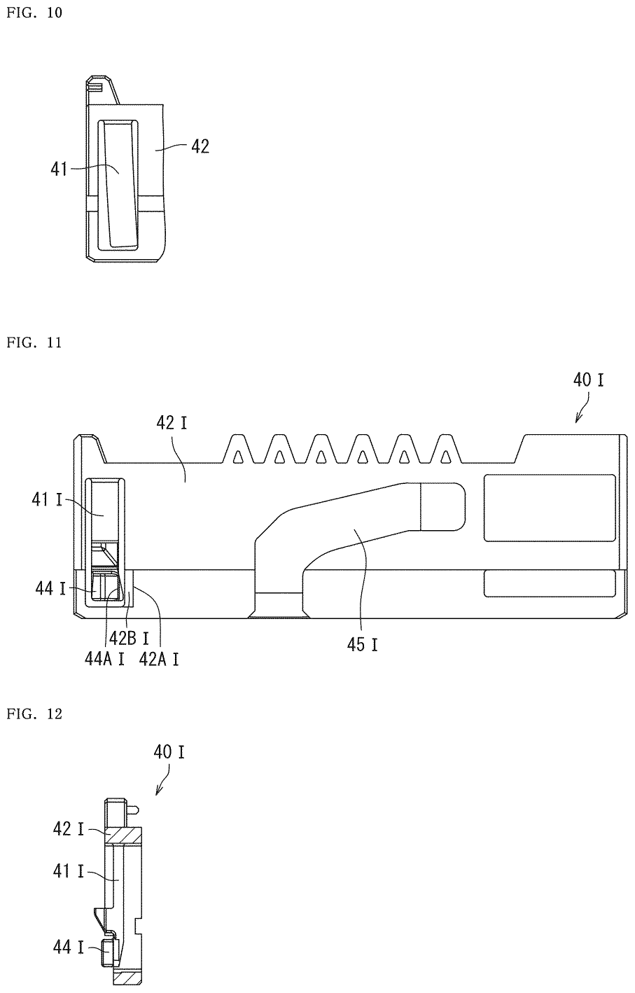

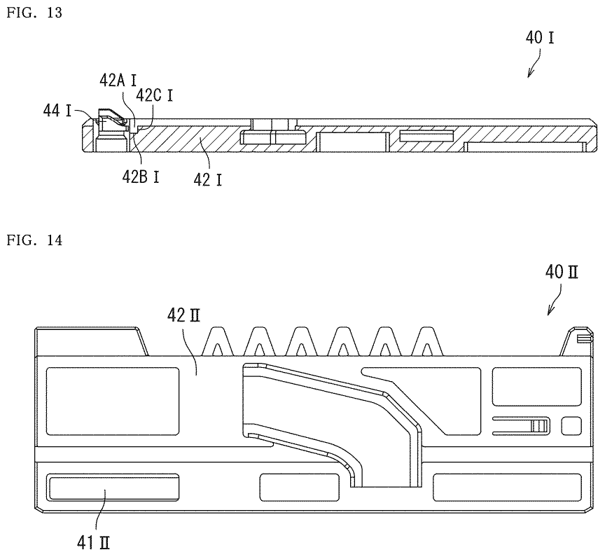

FIG. 6A is an isometric view schematically showing a slider of the connector of the present disclosure. FIG. 6B is a front view schematically showing an inner main face of the slider of the connector of the present disclosure. FIG. 6C is a cross-sectional view schematically showing the slider of the connector of the present disclosure. FIG. 6D is a cross-sectional view schematically showing the slider of the connector of the present disclosure as seen from one end face side. FIG. 7 is an isometric view schematically showing a cover with the operation lever of the connector of the present disclosure pivotally supported thereon. FIG. 8 is an isometric view schematically showing a mating connector matable with the connector of the present disclosure. FIG. 9 is a front view schematically showing the connector of the present disclosure (the outer housing which is a component thereof is not shown) at the time of unexpected turning of the operation lever before temporary mating with the mating connector. FIG. 10 is a partially enlarged front view schematically showing a behavior of a catching portion of the slider which is a component of the connector of the present disclosure at the time of unexpected turning of the operation lever before temporary mating with the mating connector.

A connector 100 of the present disclosure includes, as main components, an outer housing 10, a slider provided in the outer housing 10, and an operation lever 20 combined with the slider and so attached as to be turnable or rotatable between a pre-turning first position shown in FIG. 1 and a post-turning second position.

The slider 40 slidingly moves in a predetermined direction in the outer housing 10 as the operation lever 20 is turned. That is, an operator can slidingly move the slider 40 by turning the operation lever 20 (see FIG. 6A and the like). The operation lever 20 helps to mate the connector 100 of the present disclosure with a mating connector 200 by turning operation.

In addition, the slider 40 has, on an inner main face 46 side, a cam groove 45 relative to which a cam pin 230 (see FIG. 8) of the mating connector 200, which will be described later, can move during the sliding movement in the predetermined direction mentioned above.

In the present disclosure, when the cam pin 230 is located at a first end 45a as an inlet end of the cam groove 45, temporary mating of the mating connector 200 with the connector 100 can be achieved. That is, a state of “temporary mating of a mating connector” herein refers to a provisional (incomplete) mated state of the mating connector 200 with the connector 100 of the present disclosure. Specifically, the state of “temporary mating of a mating connector” refers to a state where the operation lever 20 is in the first position, and simultaneously the cam pin 230 of the mating connector is located at the first end 45a as the inlet end of the cam groove 45 of the slider 40. In other words, a state where the operation lever 20 is in the first position can be a state where the cam pin 230 of the mating connector is located at the first end 45a as the inlet end of the cam groove 45 of the slider 40.

In addition, when the cam pin 230 is located at a terminal second end 45b opposite to the first end of the cam groove 45, final mating of the mating connector 200 with the connector 100 of the present disclosure can be achieved. That is, a state of “final mating of the mating connector” herein refers to a state where the connector 100 of the present disclosure and the mating connector 200 are completely mated with each other. Specifically, the state of “final mating of the mating connector” refers to a state where the operation lever 20 is in the second position, that is, turning of the same lever 20 is completed, and simultaneously the cam pin 230 of the mating connector is located at the second end 45b of the cam groove 45 of the slider 40. In other words, the state where the operation lever 20 is in the second position can be a state where the cam pin 230 of the mating connector is located at the second end 45b of the cam groove 45 of the slider 40.

The outer housing 10 can be configured to be capable of accommodating an entire inner housing 50 and part of the mating connector 200. The outer housing 10 has a first inner space 14 with a first opening portion 11 in a direction of mating with the mating connector 200. The first inner space 14 is formed by a body portion 12 of the outer housing 10.

Through this first opening portion 11, the inner housing 50 and the mating connector 200 can be inserted and arranged in the first inner space 14. The inner housing 50 has a plurality of through portions 51 in the mating direction of the mating connector 200 accommodating male contacts 210 (see FIG. 8) of the mating connector 200 and contactable with the same contacts.

In addition, in the first inner space 14 of the outer housing 10, with the inner housing 50 arranged therein, a continuous space 13 can be provided between the body portion 12 of the outer housing 10 and the inner housing 50. This continuous space 13 can be a space for inserting an enclosing portion 220 accommodating the male contacts 210 of the mating connector 200 mentioned above (see FIG. 4E). During mating of the mating connector 200, the enclosing portion 220 of the mating connector 200 is located in this continuous space 13.

The body portion 12 of the outer housing 10 has, therein, a second inner space 16 with a second opening portion 15 in a direction intersecting the mating direction of the mating connector 200 mentioned above, for example in a direction perpendicular thereto. Two second inner spaces 16 can be provided in the body portion 12 of the outer housing 10.

The slider 40 (see FIGS. 6A to 6D) can be inserted through such a second opening portion 15, and retained in the second inner space 16. Herein, this second inner space 16 can also be referred to as a “slider retaining space”. In addition, the inserted slider 40 is slidingly movable in the second inner space 16 in the predetermined direction, for example a direction perpendicular to the mating direction of the mating connector 200 mentioned above.

A cover 30 can be attached to the body portion 12 of the outer housing 10 from a direction opposite to the mating direction of the mating connector 200 mentioned above, that is, from a side opposite to the first opening portion 11.

The cover 30 can draw and align electrical wires connected to a plurality of terminals plugged in the connector of the present disclosure in a predetermined routing direction. The operation lever 20 can extend across the cover 30 along a short-side direction of the connector, and be pivotally supported on opposite sides of the cover 30 so as to be turnable or rotatable.

The connector 100 of the present disclosure may include a retainer plugged in the inner housing 50. The retainer may position and secure terminals of the mating connector in the inner housing 50. In addition, the connector 100 of the present disclosure may further include a seal material for waterproofing. For example, the connector 100 may include the seal material on an inner face and/or an outer periphery of the inner housing 50. The seal material may waterproof the terminals in the connector, and shut off water between the inner housing 50 and the mating connector 200, for example.

In addition, the components such as a housing such as the outer housing 10, the slider 40, the operation lever 20, and the cover 30 may be formed from an electrically insulating non-conductive material. These electrically insulating components may include a resin material having an electrically insulating property. Such electrically insulating components may include, but be not limited to, at least one kind of thermosetting resin selected from the group consisting of epoxy resins, phenolic resins, silicone resins, and unsaturated polyester resins, for example. In addition, members different from each other may include respective different resin materials.

Having the configuration described above as a premise, the present disclosure is characterized by the following points.

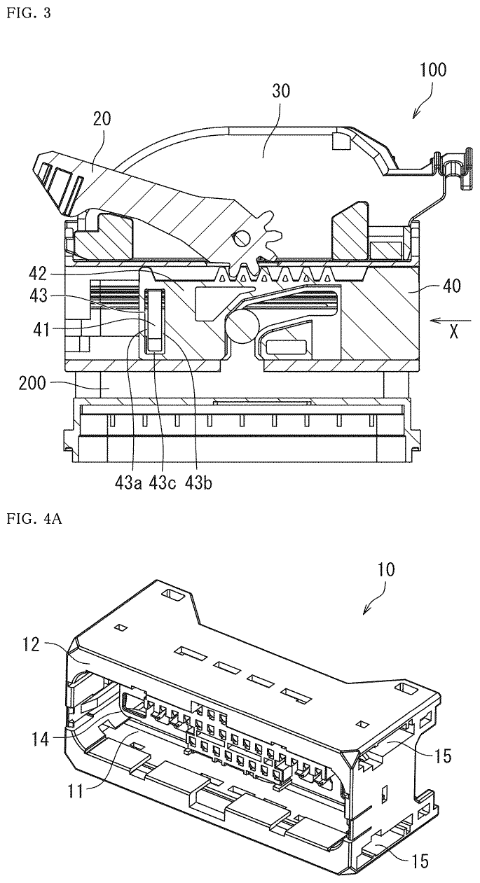

Specifically, the slider 40 mentioned above has a catching portion 41 having deflectability at a predetermined spot, and the outer housing 10 has a caught portion 17 on which the catching portion 41 of the slider 40 can be caught. In an example, as shown in FIGS. 3, 6B, and the like, the catching portion 41 of the slider 40 can be configured to have its long sides extending in a direction substantially perpendicular to a moving direction X of the slider 40.

The catching portion 41 of the slider 40, with the operation lever 20 in the first position mentioned above, can be caught on the caught portion 17 of the outer housing 10. Then, temporary mating of the mating connector 200 causes the mating connector 200 to abut against the catching portion 41 of the slider 40, allowing the catching portion 41 to deflect, thereby enabling the slider 40 to be released from a caught state on the caught portion 17 of the outer housing 10.

Having such a feature enables the catching portion 41 of the slider 40 in the caught state on the caught portion 17 of the outer housing 10 to be retained before the temporary mating of the mating connector 200. That is, the operation lever 20 can be retained in the pre-turning first position.

On the other hand, the release of the catching portion 41 of the slider 40 from the caught state during the temporary mating of the mating connector 200 enables the operation lever 20 to be turned from the pre-turning first position toward the post-turning second portion to slidingly move the slider in the predetermined direction. In the present disclosure, when such a sliding movement of the slider 40 is completed, final mating of the mating connector 200 with the connector 100 of the present disclosure becomes possible.

Also from the above, in the present disclosure, unless the temporary mating of the mating connector 200 is done, the abutment of the mating connector 200 against the catching portion 41 of the slider 40 and the subsequent deflection of the catching portion 41 to release the catching portion 41 of the slider 40 from the caught state do not occur. Therefore, even if an external force to turn the operation lever 20 from the pre-turning first position toward the post-turning second position acts before the temporary mating of the mating connector 200, the catching portion 41 of the slider 40 in the caught state on the caught portion 17 of the outer housing 10 is retained, so that the operation lever 20 can be retained in the pre-turning first position (see FIG. 9). For this reason, according to the connector 100 of the present disclosure, a more suitable operation lever retaining mechanism can be provided.

An example of the catching portion 41 of the slider 40 having deflectability mentioned above will be described below. The catching portion 41 is provided inside a slit 43 formed in a body portion 42 of the slider 40 (see FIGS. 3, 6A, and the like). Specifically, the catching portion 41 having deflectability can be provided by providing a first slit 43a and a second slit 43b opposite to each other and a third slit 43c connecting these two slits 43a, 43b in the body portion 42 of the slider. A protrusion 44 is provided at an end of this catching portion 41.

In addition, the outer housing 10 mentioned above has an inner wall portion 18 forming part of the second inner space 16 for retaining the slider 40. This inner wall portion 18 has an opening portion 19 in which the protrusion 44 of the above catching portion 41 can be located.

In the present disclosure, with the operation lever 20 in the pre-turning first position, the protrusion 44 of the catching portion 41 can be caught on a catching wall forming the opening portion 19 of the outer housing 10. This avoids a sliding movement of the slider 40, and the pre-turning first position of the operation lever 20 accompanying the movement of the slider 40 is retained.

Further, in the case where the deflectable catching portion 41 is provided by forming the slit 43, the mating connector 200 can abut against the protrusion 44 of the catching portion 41 during the temporary mating of the mating connector 200.

Such abutment causes the catching portion 41 to deflect, since the catching portion 41 has deflectability, enabling the protrusion 44 of the catching portion 41 to be released from being caught on the catching wall forming the opening portion 19 of the outer housing 10. This makes the slider 40 slidingly movable in the predetermined direction, thereby enabling the operation lever 20 to be turned from the pre-turning first position toward the post-turning second position.

Further, in the present disclosure, the second inner space 16 as the slider retaining space locally has a catching portion accommodating space at an end side thereof in which the catching portion 41 of the slider 40 after completion of the sliding movement can be accommodated. Since the catching portion 41 is accommodated in such a catching portion accommodating space, the slider 40 can avoid slidingly moving again in a direction opposite to the predetermined direction mentioned above. This suitably enables the operation lever 20 to avoid returning from the post-turning second position to the pre-turning first position after the operation lever 20 is turned.

In the present disclosure, it is preferred that the connector 100 take the following aspect. As described above, in the present disclosure, before the temporary mating of the mating connector 200, the catching portion 41 of the slider 40 is caught on the caught portion 17 of the outer housing 10. Specifically, the protrusion 44 of the catching portion 41 can be caught on the catching wall forming the opening portion 19 (see FIG. 4B) of the outer housing 10.

In this point, before the temporary mating of the mating connector 200, due to the catching portion 41 having deflectability, distortion (or twist) may occur in the catching portion 41, causing the catching portion 41 to be unexpectedly released from being caught on the caught portion 17.

In view of this point, as shown in FIG. 11, it is preferred that a catching portion 41I in a front view have a local inclined portion 44AI on a side of a protrusion 44I thereof, and that an inner main face of a body portion 421 of a slider 40I locally have a cutout portion 42AI abuttable against this local inclined portion 44AI.

This cutout portion 42AI, due to its form, has a first cutout face 42BI extending in the moving direction of the slider 40, and a second cutout face 42CI extending in a direction substantially perpendicular to the moving direction of the slider 40.

By taking such a configuration, even if distortion occurs in the deflectable catching portion 41, causing a force by which the catching portion 41 is unexpectedly released from being caught on the caught portion 17, the local inclined portion 44AI of the catching portion 41I can abut against both the first cutout face 42BI extending in the moving direction of the slider 40 and the second cutout face 42CI extending in the direction substantially perpendicular to the moving direction of the slider 40.

This can suitably avoid the unexpected release of the catching portion 41 from being caught on the caught portion 17 even if a distortion force occurs in the deflectable catching portion 41 before the temporary mating of the mating connector 200.

In addition, if the feature of the present disclosure described above is provided, the feature is not limited to the configuration where, as shown in FIGS. 3, 6B, and the like, the long sides of the catching portion 41 of the slider 40 extend in the direction substantially perpendicular to the moving direction X of the slider 40. For example, as shown in FIG. 14, a configuration may be employed where the long sides of the catching portion 41II of the slider 40II extend in a direction substantially parallel to the moving direction X of the slider 40II.

A mode of use of the connector 100 of the present disclosure will be described below.

First, the slider 40 is inserted through the second opening portion 15 of the outer housing 10 (see FIGS. 4A, 4B, and the like). Such insertion is performed until the deflective catching portion 41 provided at a predetermined spot in the slider 40 is enabled to be caught on the caught portion 17 of the outer housing 10. The catching portion 41 of the slider 40, with the operation lever 20 in the first position mentioned above, can be caught on the caught portion 17 of the outer housing 10.

In addition, with the operation lever 20 pivotally supported on the cover 30 in the pre-turning first position, the cover 30 is attached to the outer housing 10. In addition, the inner housing 50 is arranged in the outer housing 10 (see FIGS. 1, 4E, 9, and the like).

As described in the above configuration section of the present disclosure, in the present disclosure, before the temporary mating of the mating connector 200, the catching portion 41 of the slider 40 in the caught state on the caught portion 17 of the outer housing 10 is retained, so that the operation lever 20 can be retained in the pre-turning first position.

Also from the above, unless the temporary mating of the mating connector 200 is done, the abutment of the mating connector 200 against the catching portion 41 of the slider 40 and the subsequent deflection of the catching portion 41 to release the catching portion 41 of the slider 40 from the caught state do not occur.

Therefore, even if an external force to turn the operation lever 20 from the pre-turning first position toward the post-turning second position acts before the temporary mating of the mating connector 200, the catching portion 41, as shown in FIG. 10, only shows a movement to abut against the body portion 42 of the slider 40 while the catching portion 41 of the slider 40 in the caught state on the caught portion 17 of the outer housing 10 is being retained. This enables the operation lever 20 to be retained in the pre-turning first position before the temporary mating of the mating connector 200.

Next, with the inner housing 50 arranged, the enclosing portion 220 of the mating connector 200 is inserted into the continuous space 13 provided between the body portion 12 of the outer housing 10 and the inner housing 50. By such insertion, the temporary mating of the mating connector 200 with the connector 100 of the present disclosure is performed.

In the present disclosure, the temporary mating of the mating connector 200 causes the mating connector 200 to abut against the catching portion 41 of the slider 40, allowing the catching portion 41 to be deflected. This causes the catching portion 41 of the slider 40 to be released from the caught state on the caught portion 17 of the outer housing 10.

Such release of the catching portion 41 of the slider 40 from the caught state during the temporary mating enables the operation lever 20 to be turned from the pre-turning first position toward the post-turning second position to slidingly move the slider 40 in the predetermined direction. Thereafter, when the sliding movement of the slider 40 is completed, the final mating of the mating connector 200 with the connector 100 of the present disclosure is performed.

Embodiments of the present disclosure have been described above, but the present disclosure is not limited to these, and various modifications based on knowledge of a person skilled in the art, such as combining the above configurations, may be made without departing from the spirit of the claims.

1. A connector adapted to mate with a mating connector, comprising:
an outer housing adapted to receive the mating connector, and including a catching portion;
a slider provided in the outer housing and slidingly movable in a predetermined direction the slider including a catching portion adapted to deflect at a predetermined position and be caught by the catching portion of the outer housing; and
an operation lever combined with the slider and adapted to be turned between a pre-turning first position and a post-turning second position, the slider is slidingly movable with turning of the operation lever, wherein the catching portion of the slider, with the operation lever in the first position, can be caught on the caught portion of the outer housing.

2. The connector according to claim 1, wherein temporary mating of the mating connector causes the mating connector to abut against the catching portion of the slider to deflect the catching portion, thereby enabling the catching portion to be released from a caught state on the caught portion.

3. The connector according to claim 2, wherein, before the temporary mating of the mating connector, the catching portion in the caught state on the caught portion is retained, and the operation lever is retained in the first position.

4. The connector according to claim 2, wherein the release of the catching portion from the caught state during the temporary mating of the mating connector enables the operation lever to be turned from the first position toward the second position to slidingly move the slider in the predetermined direction.

5. The connector according to claim 2, wherein the outer housing has a slider retaining space capable of retaining the slider therein.

6. The connector according to claim 5, wherein the slider retaining space locally has, at an end side thereof, a catching portion accommodating space capable of accommodating the catching portion of the slider after the sliding movement is completed.

7. The connector according to claim 2, wherein the deflectable catching portion has a protrusion at a distal-end side.

8. The connector according to claim 7, wherein the outer housing has a slider retaining space adapted to retain the slider therein.

9. The connector according to claim 8, wherein an inner wall portion of the outer housing forming part of the slider retaining space has an opening portion in which the protrusion is locatable.

10. The connector according to claim 2, wherein the catching portion of the slider is provided inside a slit formed in a body portion of the slider.

11. A connector matable with a mating connector, comprising:
an outer housing capable of receiving therein the mating connector inserted thereinto; a slider provided in the outer housing and slidingly movable in a predetermined direction; and an operation lever combined with the slider and turnable between a pre-turning first position and a post-turning second position, wherein
the slider is slidingly movable with turning of the operation lever, and has a catching portion having deflectability at a predetermined position,
the outer housing has a caught portion on which the catching portion of the slider can be caught,
the catching portion of the slider, with the operation lever in the first position, can be caught on the caught portion of the outer housing, and
temporary mating of the mating connector causes the mating connector to abut against the catching portion of the slider to deflect the catching portion, thereby enabling the catching portion to be released from a caught state on the caught portion.

12. The connector according to claim 11, wherein the catching portion in the caught state on the caught portion is retained and the operation lever is retained in the first position prior to the temporary mating of the mating connector.

13. The connector according to claim 11, wherein the operation lever to be turned from the first position toward the second position to slidingly move the slider in the predetermined direction is enabled by the release of the catching portion from the caught state during the temporary mating of the mating connector.

14. The connector according to claim 11, wherein the outer housing defines a slider retaining space adapted to retain the slider therein.

15. The connector according to claim 14, wherein the slider retaining space includes a catching portion accommodating space adapted to accommodate the catching portion of the slider.

16. The connector according to claim 11, wherein the deflectable catching portion has a protrusion at a distal-end side thereof, and the outer housing has a slider retaining space adapted to retain the slider therein.

17. The connector according to claim 16, wherein an inner wall portion of the outer housing forming part of the slider retaining space defines an opening portion in which the protrusion is arranged.

18. The connector according to claim 11, wherein the catching portion of the slider is arranged inside a slit formed in a body portion of the slider.
